(19) United States
(12) Patent Application Publication
(10) Pub. No.: US 2008/0218663 A1
(43) Pub. Date: Sep. 11, 2008

(54) FLUORESCENT TUBE DRIVING METHOD AND APPARATUS

(75) Inventor: Katsumi Kobori, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/041,332

(22) Filed: Mar. 3, 2008

(30) Foreign Application Priority Data
Mar. 5, 2007 (JP) 2007-054364

(51) Int. Cl. G02F 1/1335; H05B 41/14

(52) U.S. Cl. 349/70; 315/247

(57) ABSTRACT

A fluorescent tube driving method for driving a fluorescent tube on the basis of an alternating current driving signal generated by an inverter circuit that uses a direct current power supply produced by directly rectifying the voltage of a commercial power supply includes the steps of: detecting an input voltage supplied to the inverter circuit by a voltage detector; detecting an output current of the inverter circuit that drives the fluorescent tube on the basis of the alternating current driving signal by using an electric current detector; and controlling an alternating current driving signal generated by the inverter circuit on the basis of the output current of the inverter circuit, which is detected by the electric current detector, and an input voltage supplied to the inverter circuit, the input voltage being detected by the voltage detector, and suppressing a variation in the output current detected by the electric current detector.

### CROSS REFERENCES TO RELATED APPLICATIONS

The present invention contains subject matter related to Japanese Patent Application JP 2007-054364 filed in the Japanese Patent Office on Mar. 5, 2007, the entire contents of which are incorporated herein by reference.

### BACKGROUND OF THE INVENTION

1. Field of the Invention

The present invention relates to a fluorescent tube driving method and apparatus for stabilizing electric current flowing through a fluorescent tube with respect to a variation in an input voltage and for driving the fluorescent tube.

2. Description of the Related Art

FIG. 6 is a circuit diagram showing the configuration of a power-supply block in which an inverter circuit for driving, for example, a cold cathode tube (hereinafter referred to as a cold cathode fluorescent tube (CCFT)) is provided.

A plurality of fluorescent tubes are used in a backlight for a large LCD panel. In order to cause these fluorescent tubes to emit light, an inverter circuit generates an alternating current of a high voltage of several tens of KHZ.

These CCFTs used as fluorescent tubes have a negative resistance characteristic. In order to allow one inverter circuit (transformer) to drive a plurality of fluorescent tubes in parallel, a function of causing electric current flowing through each fluorescent tube to be balanced by using a balance capacitor is necessary.

As functions of causing electric current flowing through each fluorescent tube when a plurality of fluorescent tubes are to be driven in parallel to be balanced, a system in which a transformer is used, a system in which a constant current circuit is used, and others have been proposed.

It is necessary for backlight units (BLU) in a set to ensure necessary luminance and to stably maintain the luminance. An inverter circuit has a function of controlling a total electric current Io required by the fluorescent tubes to be constant.

As is clear from the configuration of the power-supply block shown in FIG. 6, for input to the inverter circuit, in general, stabilized DC voltage on the power-supply secondary side or stabilized DC voltage (an output of a power factor improvement circuit “PFC” for dealing with harmonic regulations, in general, approximately DC 380V) via a PFC on the power-supply primary side is used, and no consideration is given to variations in the input voltage.

Furthermore, in an inverter circuit that uses, as an input, a stabilized voltage such that electric power is supplied from the power-supply block shown in FIG. 6, Io is controlled to be constant so as to maintain luminance as constant.

Since the impedance of the CCFT changes with temperature and electric current, PWM control (the ratio of conduction time to non-conduction time is changed) for changing the conduction time of a switching element of the inverter circuit, and PFM control for changing a driving frequency are performed to change an output voltage Eo of an inverter transformer T1 so as to control Io to be constant.

A change in the impedance of the CCFT is comparatively small, and the change width of PWM control is slight. The power factor (work rate) determined by a phase difference between a voltage applied to a CCFT and an electric current does not change much even if the impedance of the CCFT is changed a little, and the change in the effective electric current flowing through the CCFT falls within a range in which a problem is not posed in practical terms (the amount of change of the effective electric current is approximately several %).

The number of produced liquid-crystal TVs has increased, competition in terms of price in the market is fierce, and the reduction of the cost price is strongly desired.

The reduction of the power consumption of the TV set has become a major problem.

In the manner described above, the inverter circuit in the current situation operates at a stable DC voltage supplied from the power-supply block shown in FIG. 6.

In the power-supply block shown in FIG. 6, commercial power supply is rectified using a rectification circuit 51, and a DC voltage is generated by a configuration including a switching regulator and is supplied to the inverter circuit.

That is, the stable DC voltage on the primary side is a PFC output, and the stable output on the secondary side is a DC output of the power supply.

In the power-supply block shown in FIG. 6, a power-supply unit 53 constituted by a PFC unit 52, a transistor Q2, and the like performs voltage conversion, and an electric power loss is large.

When a DC output having a large variation, the DC output being produced by only rectifying and smoothing the voltage of a commercial power supply, is used for the input of the inverter circuit in place of an output from the PFC unit 52 and the power-supply unit 53 shown in FIG. 6, the voltage conversion of the electric power consumed by the switching regulator becomes unnecessary, the electric power of the power-supply block becomes ⅓ or lower by taking the input of the inverter from a rectification and smoothing unit, and the amount of electric power to be input to the inverter is reduced, thereby making it possible to greatly reduce the power-supply cost used for the input of the inverter circuit and the electric power loss.

However, when a voltage produced by rectifying and smoothing the voltage of a commercial power supply is used as an input of the inverter circuit, this voltage greatly varies.

For example, the voltages of such commercial power supplies differ among countries, for example, AC 100V in Japan, 110V to 135V in North America, and 200V to 240V in 200V areas in Europe. Furthermore, there is a variation with respect to a nominal voltage. If this variation is set at 15%, the voltage after being rectified and smoothed becomes DC 100V to 390V. Even if the voltage in a 100V area is double-voltage-rectified and the voltage in a 200V area is full-width-rectified, it is necessary to support an input voltage range of DC 200V to 440V. For this purpose, it is necessary to greatly increase the width of the PWM control of the inverter circuit.

As a device for suppressing a variation in the effective value of fluorescent tube lighting electric current with respect to a variation in the input voltage supplied to the inverter circuit, there is a fluorescent lamp inverter circuit including input voltage detection means for detecting an input voltage supplied to an inverter for supplying electric power to a fluorescent tube; signal generation means for generating a signal for turning on the fluorescent tube; and frequency adjustment means for changing the frequency of the signal generated by the signal generation means in response to a voltage value detected by the input voltage detection means (see Japanese Unexamined Patent Application Publication No. 11-214185).

### SUMMARY OF THE INVENTION

Therefore, in the fluorescent tube driving method and apparatus of the related art, increasing the width of the control range of PWM has already achieved actual results in various fields and is not a major problem. However, when the ON time is short (when the input voltage is high) and the ON time is long (the input voltage is low), the power factor changes. Therefore, even if the output current Io of the inverter transformer is controlled to be constant, there is a problem in that the effective electric current that flows through a CCFT greatly changes.

The present invention has been made in view of such circumstances. It is desirable to provide a fluorescent tube driving method and apparatus capable of stabilizing an effective electric current that flows through a fluorescent tube with respect to an input voltage over a wide range.

According to an embodiment of the present invention, there is provided a fluorescent tube driving method for driving a fluorescent tube on the basis of an alternating current driving signal generated by an inverter circuit that uses a direct current power-supply produced by directly rectifying the voltage of a commercial power supply as an input, the fluorescent tube driving method comprising the steps of: detecting an input voltage supplied to the inverter circuit by using voltage detection means; detecting an output current of the inverter circuit that drives the fluorescent tube on the basis of the alternating current driving signal by using electric current detection means; and controlling, by using a controller, an alternating current driving signal generated by the inverter circuit on the basis of the output current of the inverter circuit, the output current being detected by the electric current detection means, and an input voltage supplied to the inverter circuit, the input voltage being detected by the voltage detection means, and suppressing a variation in the output current detected by the electric current detection means.

According to another embodiment of the present invention, there is provided an inverter circuit for driving a fluorescent tube on the basis of an alternating current driving signal that is generated in such a manner that a direct current power supply produced by directly rectifying a commercial power supply is used as an input, the inverter circuit including: a conversion circuit configured to generate the alternating current driving signal on the basis of the direct current power supply; voltage detection means configured to detect an input voltage supplied to the conversion circuit; electric current detection means configured to detect the output current of the conversion circuit for driving the fluorescent tube on the basis of an alternating current driving signal; and a controller configured to control the alternating current driving signal generated by the conversion circuit on the basis of the output current of the conversion circuit, which is detected by the electric current detection means, and the input voltage supplied to the conversion circuit, which is detected by the voltage detection means, and suppresses a variation in the output current detected by the electric current detection means.

According to another embodiment of the present invention, there is provided a display apparatus including: a liquid-crystal panel configured to display an image; and a backlight apparatus configured to illuminate the liquid-crystal panel, wherein the backlight apparatus includes a fluorescent tube; and an inverter circuit, and wherein the inverter circuit includes a conversion circuit configured to generate an alternating current driving signal for driving the fluorescent tube on the basis of a direct current power supply produced by directly rectifying a commercial power supply; voltage detection means configured to detect an input voltage supplied to the conversion circuit; and electric current detection means configured to detect the output current of the conversion circuit for driving the fluorescent tube on the basis of the alternating current driving signal; and a controller configured to control the alternating current driving signal generated by the conversion circuit on the basis of the output current of the conversion circuit, the output current being detected by the electric current detection means, and the input voltage supplied to the conversion circuit, the input voltage being detected by the voltage detection means, and configured to suppress a variation in the output current detected by the electric current detection means.

According to another embodiment of the present invention, there is provided a backlight apparatus for illuminating a liquid-crystal panel for displaying an image, the backlight apparatus including: a fluorescent tube; and an inverter circuit, wherein the inverter circuit includes a conversion circuit configured to generate an alternating current driving signal for driving the fluorescent tube on the basis of a direct current power supply produced by directly rectifying a commercial power supply; voltage detection means configured to detect an input voltage supplied to the conversion circuit; and electric current detection means configured to detect the output current of the conversion circuit for driving the fluorescent tube on the basis of the alternating current driving signal; and a controller configured to control the alternating current driving signal generated by the conversion circuit on the basis of the output current of the conversion circuit, the output current being detected by the electric current detection means, and the input voltage supplied to the conversion circuit, the input voltage being detected by the voltage detection means, and configured to suppress a variation in the output current detected by the electric current detection means.

According to the embodiments of the present invention, there is the advantage that, even if an input voltage varies over a wide range, an effective electric current flowing through a fluorescent tube can be stabilized and used for driving.

### BRIEF DESCRIPTION OF THE DRAWINGS

FIG. 1 is a circuit diagram showing the configuration of an inverter circuit to which a fluorescent tube driving method according to a first embodiment of the present invention is applied;

FIG. 2 is a characteristic diagram showing a total electric current Io of fluorescent tubes and a transformer output current of an inverter transformer T1 according to the first embodiment of the present invention;

FIG. 3 is a circuit diagram showing the configuration of an inverter circuit in which a fluorescent tube driving method according to a third embodiment of the present invention is applied;

FIG. 4 is a timing chart showing the operation of features of the inverter circuit according to the third embodiment of the present invention;

FIG. 5 is a block diagram showing the configuration of a display apparatus according to a fourth embodiment of the present invention; and

FIG. 6 is a circuit diagram showing the configuration of a power-supply block in which an inverter circuit for driving a cold cathode tube is disposed.

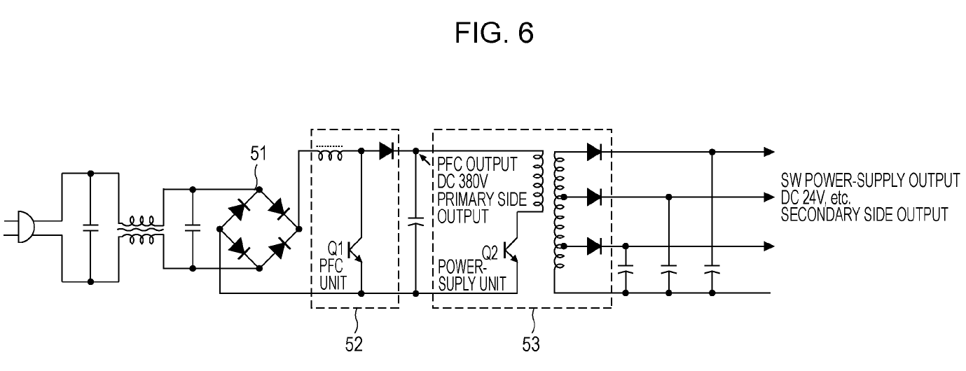

### DESCRIPTION OF THE PREFERRED EMBODIMENTS

### First Embodiment

Next, with reference to the drawings, a description will be given of a fluorescent tube driving method and apparatus according to a first embodiment of the present invention.

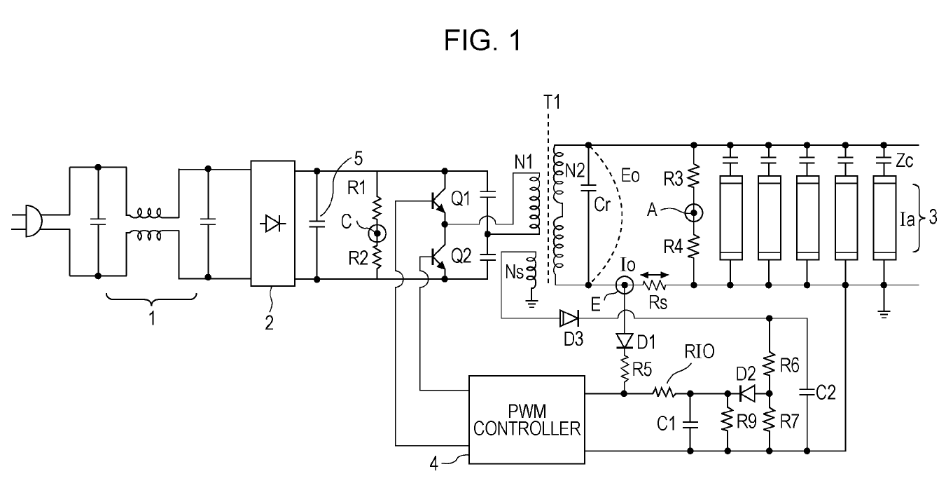

FIG. 1 is a circuit diagram showing the configuration of an inverter circuit to which a fluorescent tube driving method according to the first embodiment of the present invention is applied.

The inverter circuit includes a noise filter circuit 1 for suppressing noise components taken from a commercial power supply; a rectification circuit 2 for converting AC electric power into DC electric power; a smoothing capacitor 5; a serial circuit (voltage detection means) formed of a resistor R1 and a resistor R2, which are connected to the output of the rectification circuit 2 for detecting an AC voltage supplied from the commercial power supply; switch transistors (conversion circuits) Q1 and Q2 for alternately driving the primary side winding wire N1 of an inverter transformer T1 by PWM control; and a serial capacitor that is connected in series with the primary side winding wire N1 of the inverter transformer T1.

Furthermore, a parallel capacitor Cr is connected between output terminals of a secondary side winding wire N2 of the inverter transformer T1. Also, a serial circuit (voltage detection means), which is formed of a resistor R3 and a resistor R4, for detecting the output voltage of the secondary side of the inverter transformer T1; a plurality of fluorescent tubes 3; and balance capacitors Zc for balancing electric current Ia flowing through each fluorescent tube 3, the balance capacitors Zc each being connected in series with a corresponding one of the fluorescent tubes 3.

In a channel through which the electric current Ia of each fluorescent tube 3 flows in common, a shunt resistor (electric current detection means) Rs for detecting the total electric current Io of the electric current Ia flowing through the fluorescent tubes 3 as the amount of voltage drop is disposed.

The circuit is configured in such a manner that the amount of voltage drop that occurs across the ends of the shunt resistor Rs in proportion to the total electric current Io of the electric current Ia flowing through each fluorescent tube 3 is detected as a DC voltage by a serial circuit formed of a diode D1 and a resistor R5.

For this reason, the detection point E on the secondary side winding wire N2 side of the inverter transformer T1 of the shunt resistor Rs is connected to the input of the PWM controller 4 via the serial circuit formed of the diode D1 and the resistor R5. Furthermore, a parallel circuit formed of a capacitor C1 and a resistor R9 is connected to the input of the PWM controller 4 via a resistor R10.

A detection winding wire Ns for detecting an AC input voltage on the primary side is disposed in the inverter transformer T1. A diode D3 is connected to the detection winding wire Ns.

The cathode of the diode D3 is connected to one of the terminals of the capacitor C2, and the capacitor C2 is connected in parallel with a serial circuit formed of a resistor R6 and a resistor R7.

The connection point between the resistor R6 and the resistor R7 is connected to the input of the PWM controller 4 to which a parallel circuit of the capacitor C1 and the resistor R9 is connected via a diode D2.

The PWM controller 4 including the parallel circuit of the capacitor C1 and the resistor R9, the capacitor C2, the serial circuit of the resistor R6 and the resistor R7, and the diode D2 corresponds to the controller of the inverter circuit, a display apparatus, and a backlight apparatus (to be described later).

In the PWM controller 4, on the basis of the AC input voltage on the primary side of the inverter transformer T1, which is detected by the detection winding wire Ns, and the amount of voltage drop proportional to the total electric current Io of the electric current Ia flowing through each fluorescent tube 3, which is detected from the detection point E, a PWM-controlled transistor driving signal for maintaining the total electric current Io of the electric current Ia flowing through each fluorescent tube 3 as constant according to the AC input voltage on the primary side of the inverter transformer T1 is generated, and is supplied to the bases of the switch transistors Q1 and Q2, so that the on/off states of the switch transistors Q1 and Q2 and the periods thereof are controlled.

Next, the operation of the first embodiment of the present invention will be described.

In the inverter circuit, the AC commercial power supply supplied via the noise filter 1 is converted into DC voltage by the rectification circuit 2 and is applied to the switch transistors Q1 and Q2.

On the other hand, in the PWM controller 4, a voltage signal at the detection point E in response to the total electric current Io of the fluorescent tubes 3, which flows through the shunt resistor Rs, is converted into a DC voltage after passing through the serial circuit formed of the diode D1 and the resistor R5 and is input to the PWM controller 4.

As a result, the PWM controller 4 generates a transistor driving signal by PWM control so that the total electric current Io of the fluorescent tubes 3, which flows through the shunt resistor Rs, becomes a predetermined electric current value, and supplies it to the bases of the switch transistors Q1 and Q2 so as to control the on/off states of the switch transistors Q1 and Q2 and the periods thereof.

Then, by causing an alternating electric current in a pulse shape to flow through the primary side winding wire N1 of the inverter transformer T1, the primary side winding wire N1 of the inverter transformer T1 is excited. As a result, a secondary side voltage Eo is generated in the secondary side winding wire N2, and the secondary side voltage Eo is applied to the serial circuit formed of the resistor R3 and the resistor R4 and to the serial circuit formed of the fluorescent tube 3 and the balance capacitor Zc, so that the fluorescent tube 3 are turned on.

At this time, the electric current Ia flowing through the fluorescent tubes 3 are balanced by the balance capacitors Zc, and in the state in which each fluorescent tube 3 is turned on, a balanced state is reached, that is, a state in which no variation occurs in the luminance for each fluorescent tube 3 is reached.

On the other hand, the total electric current Io of the fluorescent tubes 3, which flows through the shunt resistor Rs, is converted into a DC voltage as a result of passing through the serial circuit formed of the diode D1 and the resistor R5 as the amount of voltage drop at the detection point E, and is input to the PWM controller 4.

In this state, when the voltage value of the AC commercial power supply varies and becomes high, the DC voltage output from the rectification circuit 2 also increases, the secondary side voltage Eo of the inverter transformer T1 also increases, the electric current Ia flowing through the fluorescent tube 3 increases, and the total electric current Io of the fluorescent tubes 3 also increases more than the predetermined electric current value.

For this reason, the PWM controller 4 suppresses the amount corresponding to the increase in the total electric current Io of the fluorescent tubes 3, which flows through the shunt resistor Rs, generates a transistor driving signal in which a pulse width is controlled so that the total electric current Io of the fluorescent tubes 3 maintains the predetermined electric current value, and supplies the transistor driving signal to the bases of the switch transistors Q1 and Q2 so that the on/off states of the switch transistors Q1 and Q2 and the periods thereof are controlled.

Furthermore, when the voltage value of the AC commercial power supply varies and becomes low, the DC voltage output from the rectification circuit 2 also decreases, the secondary side voltage Eo of the inverter transformer T1 also decreases, the electric current Ia flowing through the fluorescent tube 3 also decreases, and the total electric current Io of the fluorescent tubes 3 also decreases less than the predetermined electric current value.

For this reason, the PWM controller 4 compensates for the amount corresponding to the decrease in the total electric current Io of the fluorescent tubes 3, which flows through the shunt resistor Rs, generates a transistor driving signal in which a pulse width is controlled so that the total electric current Io of the fluorescent tubes 3 maintains the predetermined electric current value, and supplies the transistor driving signal to the bases of the switch transistors Q1 and Q2 so as to control the on/off states of the switch transistors Q1 and Q2 and the periods thereof.

In the first embodiment, the total electric current Io of the fluorescent tubes 3, which flows through the shunt resistor Rs, is detected. With respect to the variation in the input voltage, the total electric current Io is maintained to a predetermined value. As a result, the effective electric current flowing through the fluorescent tube 3 is stabilized and also, by using the output of the detection winding wire Ns, the effective electric current flowing through the fluorescent tube 3 is stabilized with respect to the variation in the input voltage over a wide range, and accuracy including linearity in PWM control that is designed to stabilize the effective electric current is improved.

In particular, when the variation in the voltage value of the AC commercial power supply is large, it is not possible for only control of detecting the total electric current Io of the fluorescent tubes 3, which flows through the shunt resistor Rs and of maintaining the total electric current Io to a predetermined value to cope with a variation in the voltage value of the AC commercial power supply. Therefore, it is not possible to maintain accuracy including linearity in PWM control that is designed to stabilize an effective electric current.

When the voltage value of the AC commercial power supply varies, the output voltage from the detection winding wire Ns also varies in response to the variation in the voltage value of the AC commercial power supply.

Therefore, in the first embodiment, the total electric current Io of the fluorescent tubes 3, which flows through the shunt resistor Rs, is detected to stabilize the effective electric current flowing through the fluorescent tubes 3, and also the variation in the voltage value of the AC commercial power supply is detected using the output of the detection winding wire Ns. Then, by performing a correction process in response to the variation in the voltage value of the AC commercial power supply on a process for detecting the total electric current Io of the fluorescent tubes 3 and for stabilizing the effective electric current flowing through the fluorescent tube 3, the effective electric current flowing through the fluorescent tube with respect to the variation in the input voltage over a wide range is stabilized.

The output voltage from the detection winding wire Ns is rectified by the diode D3 and is supplied to the serial circuit formed of the resistor R6 and the resistor R7 and to the capacitor C2 connected in parallel with the serial circuit.

As a result, the output voltage from the detection winding wire Ns, which is rectified by the diode D3, is smoothed and converted into a DC voltage, and the DC voltage is divided by the serial circuit formed of the resistor R6 and the resistor R7.

Since the divided DC voltage value varies in response to the variation in the voltage value of the AC commercial power supply, the divided DC voltage value acts as the amount of correction of the voltage variation in the AC commercial power supply with respect to a voltage signal responsive to the total electric current Io of the fluorescent tubes 3, which flows through the shunt resistor Rs and which is supplied to the input of the PWM controller 4.

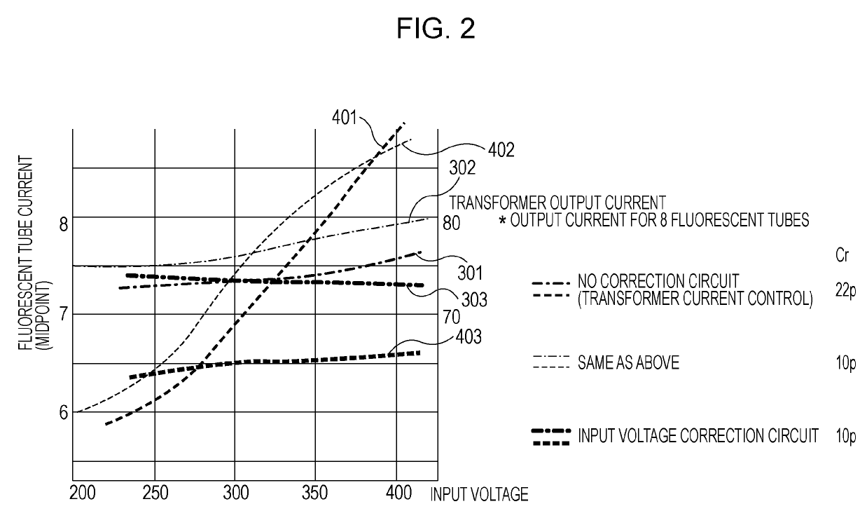

FIG. 2 is a characteristic diagram showing a total electric current Io of fluorescent tubes 3 and a transformer output current of an inverter transformer T1 in a case in which a total electric current Io of the fluorescent tubes 3 is detected and an effective electric current flowing through the fluorescent tube 3 is stabilized only on the basis of the total electric current Io and in a case in which, furthermore, a correction process using the output of the detection winding wire Ns is performed on a voltage variation in an AC commercial power supply.

The characteristic diagram showing the total electric current Io and the transformer output current shows characteristics of the total electric current Io and a transformer output current with respect to a voltage variation in the AC commercial power supply.

The characteristics indicated by reference numeral 401 show characteristics of the total electric current Io of the fluorescent tubes 3 with respect to a voltage variation in the AC commercial power supply when the parallel capacitor Cr is set at 22 p in a case in which an effective electric current flowing through the fluorescent tube 3 is stabilized only on the basis of the total electric current Io.

The characteristics indicated by reference numeral 402 show characteristics of the total electric current Io of the fluorescent tubes 3 with respect to a voltage variation in the AC commercial power supply when the parallel capacitor Cr is set at 10 p in a case in which an effective electric current flowing through the fluorescent tube 3 is stabilized only on the basis of the total electric current Io.

The characteristics indicated by reference numeral 403 show characteristics of the total electric current Io of the fluorescent tubes 3 with respect to a voltage variation in the AC commercial power supply when the parallel capacitor Cr is set at 10 p in a case in which an effective electric current flowing through the fluorescent tube 3 is stabilized on the basis of the total electric current Io and furthermore, a correction process using the output of the detection winding wire Ns is performed on a voltage variation in the AC commercial power supply.

The characteristics indicated by reference numeral 301 show characteristics of transformer output current output from the secondary side winding wire N2 of the inverter transformer T1 with respect to a voltage variation in the AC commercial power supply when the parallel capacitor Cr is set at 22 p in a case in which an effective electric current flowing through the fluorescent tube 3 is stabilized only on the basis of the total electric current Io.

The characteristics indicated by reference numeral 302 show characteristics of a transformer output current with respect to a voltage variation in the AC commercial power supply when the parallel capacitor Cr is set at 10 p in a case in which an effective electric current flowing through the fluorescent tube 3 is stabilized only on the basis of the total electric current Io.

The characteristics indicated by reference numeral 303 show characteristics of a transformer output current with respect to a voltage variation in the AC commercial power supply when the parallel capacitor Cr is set at 10 p in a case in which an effective electric current flowing through the fluorescent tube 3 is stabilized on the basis of the total electric current Io, a voltage variation in the AC commercial power supply is detected by the detection winding wire Ns, and a correction process is performed on a stabilizing process of the effective electric current flowing through the fluorescent tube 3 by detecting the total electric current Io using the output of the detection winding wire Ns.

As is clear from the characteristics indicated by reference numeral 403 for the characteristics indicated by reference numerals 401 and 402 in FIG. 2, or the characteristics indicated by reference numeral 303 for the characteristics indicated by reference numerals 301 and 302, when compared with the case in which the effective electric current flowing through the fluorescent tube 3 is stabilized only on the basis of the total electric current Io, in the case that, furthermore, the voltage variation in the AC commercial power supply is detected by the detection winding wire Ns and a correction process using the output of the detection winding wire Ns is performed, the stability for the total electric current Io of the fluorescent tubes 3, the transformer output current, and the voltage variation in the AC commercial power supply, and the accuracy including linearity in stabilization control are improved.

In the above description, the fluorescent tube driving method and apparatus can be applied to the fluorescent tube 3 including a cold cathode fluorescent tube, a hot cathode fluorescent tube, and an external electrode fluorescent tube.

As has been described above, according to the first embodiment, in PWM control in which an effective electric current flowing through the fluorescent tube 3 is stabilized, a control range sufficient to be capable of maintaining a high accuracy including linearity can be ensured, an effective electric current flowing through the fluorescent tube 3 with respect to a variation in the input voltage over a wide range can be stabilized, and luminance can be maintained to be constant when the fluorescent tube 3 is used as a backlight.

### Second Embodiment

Next, a second embodiment of the present invention will be described below.

The first embodiment is configured in such a manner that a voltage variation in the AC commercial power supply is detected using the output of the detection winding wire Ns. Alternatively, the second embodiment is configured in such a manner that a voltage variation in the AC commercial power supply is detected from a connection point C between a resistor R1 and a resistor R2 in a serial circuit formed of a resistor R1 and a resistor R2.

In this case, the DC voltage detected from the connection point C between the resistor R1 and the resistor R2 is a DC voltage divided by the resistor R1 and the resistor R2 in response to the voltage variation in the AC commercial power supply. Furthermore, the DC voltage detected from the connection point C may be taken in such a manner as to be insulated in the middle using, for example, a photocoupler circuit, and may be input to the PWM controller 4.

Also, in such a second embodiment, similarly to the first embodiment, in PWM control in which an effective electric current flowing through the fluorescent tube 3 is stabilized, a control range sufficient to be capable of maintaining a high accuracy including linearity can be ensured, an effective electric current flowing through the fluorescent tube 3 with respect to a variation in the input voltage over a wide range can be stabilized, and luminance can be maintained to be constant when the fluorescent tube 3 is used as a backlight.

### Third Embodiment

Next, a third embodiment of the present invention will be described below.

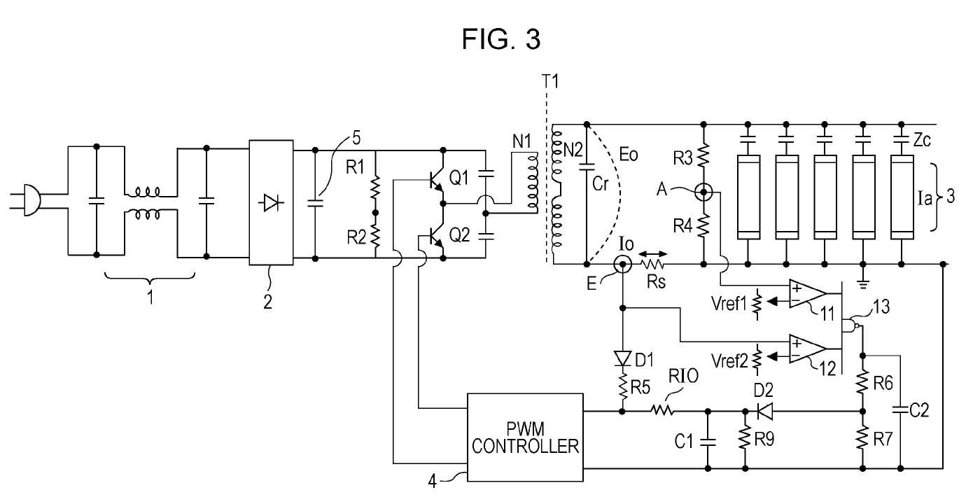

FIG. 3 is a circuit diagram showing the configuration of an inverter circuit to which a fluorescent tube driving method according to the third embodiment of the present invention is applied. Components in FIG. 3, which are identical to or correspond to the components shown in FIG. 1, are designated with the same reference numerals, and accordingly, descriptions thereof are omitted.

In the inverter circuit according to the third embodiment of the present invention, a phase difference is detected by considering that, when the voltage of the AC commercial power supply varies, a phase difference between the total electric current Io of the fluorescent tubes 3 and, for example, the secondary side voltage Eo of the inverter transformer T1 also varies.

By performing a correction process in response to the phase difference on the stabilizing process of the effective electric current flowing through the fluorescent tube 3 by using the total electric current Io, a high accuracy including linearity in PWM control for stabilizing the effective electric current flowing through the fluorescent tube 3 can be maintained, so that the effective electric current flowing through the fluorescent tube 3 with respect to a variation in the input voltage over a wide range is stabilized.

For this reason, the inverter circuit according to the third embodiment of the present invention includes a comparator 12 for detecting the phase of the total electric current Io of the fluorescent tubes 3, a comparator 11 for detecting the phase of the secondary side voltage Eo of the inverter transformer T1, and a NAND circuit 13 for detecting a phase difference between a phase signal of the total electric current Io, which is output from the comparator 12, and a phase signal of the secondary side voltage Eo of the inverter transformer T1, which is output from the comparator 11.

The output of the NAND circuit 13 is connected to the serial circuit formed of the resistor R6 and the resistor R7 and to the capacitor C2 connected in parallel with the serial circuit.

The PWM controller 4 including the comparator 11, the comparator 12, the NAND circuit 13, the parallel circuit formed of the capacitor C1 and the resistor R9, the resistor R10, the capacitor C2, the serial circuit formed of the resistor R6 and the resistor R7, and the diode D2 corresponds to the controller of the inverter circuit.

Next, the operation of the third embodiment of the present invention will be described below.

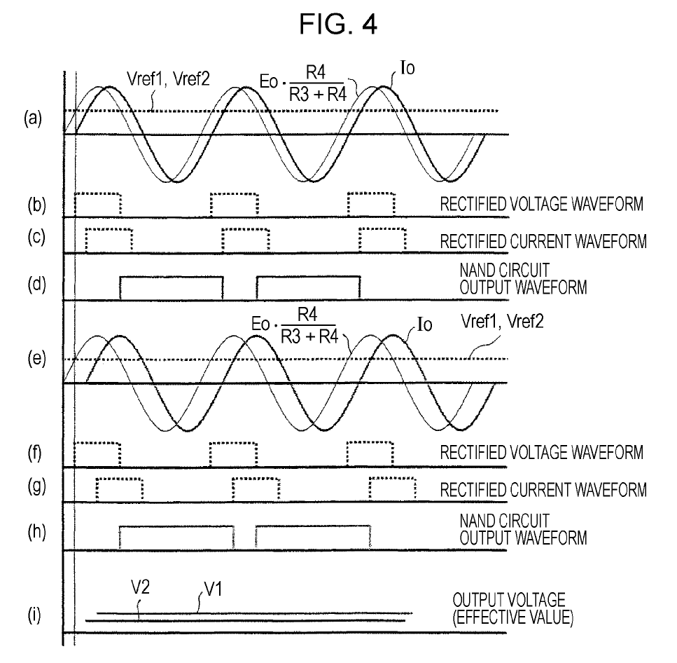

FIG. 4 is a timing chart showing the operation of features of the inverter circuit according to the third embodiment of the present invention.

The features of the inverter circuit are that the output voltage of the inverter transformer T1 is compared with a reference voltage Vref1 by the comparator 11, the output current of the inverter transformer T1 is compared with a reference voltage Vref2 by the comparator 12, the comparison results output from the comparators 11 and 12 are subjected to a computation process by the NAND circuit 13, and the output of the NAND circuit 13 is converted into a DC level.

At this time, the signal of the DC level changes in response to a phase difference between an output voltage and an output current of the inverter transformer T1, which change in response to a voltage variation in the AC commercial power supply. Therefore, correction is performed on the stabilizing process for the effective electric current flowing through the fluorescent tube 3 on the basis of the total electric current Io in response to the signal of the DC level.

That is, a correction process in response to a phase difference between the output voltage and the output current of the inverter transformer T1 is performed on the stabilizing process for the effective electric current flowing through the fluorescent tube 3 on the basis of the total electric current Io.

Part (a) of FIG. 4 shows an output voltage waveform of the inverter transformer T1 at point A of the stabilization circuit shown in FIG. 3 when the input voltage is low, and an output current waveform at point E.

Part (b) of FIG. 4 shows an output signal waveform of the comparator 11 when the output voltage of the inverter transformer T1 at point A when the input voltage is low is input to a non-inversion input terminal of the comparator 11 and is compared with the reference voltage Vref1.

Part (c) of FIG. 4 shows an output signal waveform of the comparator 12 when the output current Io of the inverter transformer T1 at point E when the input voltage is low is detected by the shunt resistor Rs, and a voltage signal proportional to an output current Io that occurs in the shunt resistor Rs is input to a non-inversion input terminal of the comparator 12 and is compared with the reference voltage Vref2.

Part (d) of FIG. 4 shows an output signal waveform of the NAND circuit 13.

Part (e) of FIG. 4 shows an output voltage waveform of the inverter transformer T1 at point A of the stabilization circuit shown in FIG. 3 when the input voltage is high, and an output current waveform at point E.

Part (f) of FIG. 4 shows an output signal waveform of the comparator 11 when the output voltage of the inverter transformer T1 at point A when the input voltage is high is input to a non-inversion input terminal of the comparator 11 and is compared with the reference voltage Vref1.

Part (g) of FIG. 4 shows an output signal waveform of the comparator 12 when the output current Io of the inverter transformer T1 at point E when the input voltage is high is detected by the shunt resistor Rs, and a voltage signal proportional to the output current Io that occurs in the shunt resistor Rs is input to a non-inversion input terminal of the comparator 12 and is compared with the reference voltage Vref2.

Part (h) of FIG. 4 shows an output signal waveform of the NAND circuit 13.

Part (i) of FIG. 4 shows an output voltage (effective value) when the output of the NAND circuit 13 is smoothed by the serial circuit formed of the resistor R6 and the resistor R7, and the capacitor C2 connected in parallel with the serial circuit, and is converted into a DC voltage.

When the output voltage shown in part (i) of FIG. 4 is compared with the output voltage V1 when the input voltage is high and is compared with the output voltage V2 when the input voltage is low, it can be seen that when the input voltage is high, the output voltage level when the output of the NAND circuit 13 is converted into a DC voltage is higher.

Therefore, by performing correction on the basis of a DC voltage V in accordance with a phase difference between the output voltage and the output current of the inverter transformer T1 on a stabilizing process for the effective electric current flowing through the fluorescent tube 3 using the total electric current Io, similarly to the first embodiment, it is possible to ensure a control range sufficient to be capable of maintaining a high accuracy including linearity in PWM control in which an effective electric current flowing through the fluorescent tube 3 is stabilized, possible to stabilize the effective electric current flowing through the fluorescent tube 3 with respect to a variation in the input voltage over a wide range, and possible to stably maintain luminance when the fluorescent tube 3 is used as a backlight.

### Fourth Embodiment

Next, a fourth embodiment of the present invention will be described below.

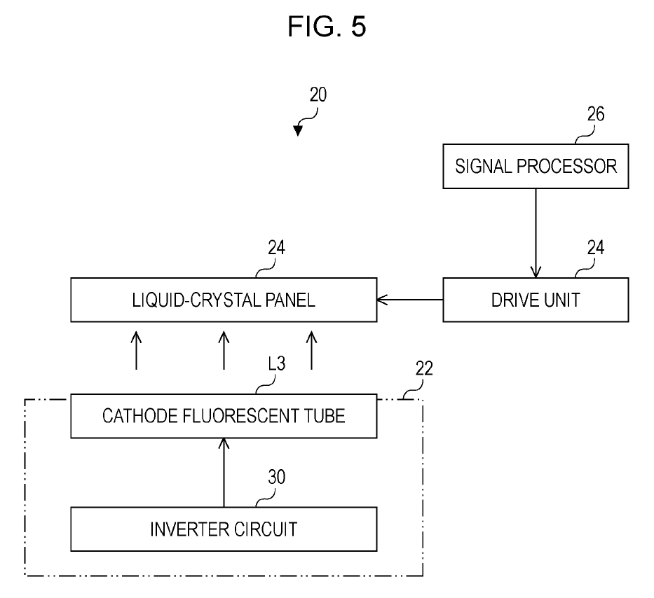

FIG. 5 is a block diagram showing the configuration of a display apparatus when the inverter circuit according to each of the above-described embodiments is used as a backlight apparatus.

A display apparatus 20 includes a backlight apparatus 22, a liquid-crystal panel 24, a signal processor 26, and a drive unit 28.

The backlight apparatus 22 is configured to include a plurality of cathode tubes L3, and an inverter circuit 30.

Each cathode tube L3 is disposed at a place facing the back side of the liquid-crystal panel 24.

The inverter circuit 30 is configured by an inverter circuit in each of the above-described embodiments, and drives a plurality of cathode tubes L3 so as to emit light.

The signal processor 26 performs signal processing on an image signal supplied from an image signal generator provided externally or internally to the display apparatus 20, and supplies the signal to the drive unit 28.

The drive unit 28 generates a driving signal for driving the liquid-crystal panel 24 on the basis of the image signal supplied from the signal processor 26, and supplies the driving signal to the liquid-crystal panel 24.

The liquid-crystal panel 24 is configured to include two transparent glass base materials, a liquid-crystal layer sandwiched between the glass base materials, a transparent electrode provided inside the glass base materials, a color filter, a polarizing plate, and the like.

In a state in which illumination light from each cathode tube L3 irradiates the liquid-crystal panel 24 from the back side by the backlight apparatus 22, the driving signal is supplied to the liquid-crystal panel 24, and the liquid-crystals of the liquid-crystal layer are driven, thereby displaying an image.

By using the backlight apparatus 22, it is possible for such a display apparatus 20 to obtain the advantage that a plurality of cathode tubes can emit light at a uniform brightness in the same manner as in the second embodiment.

It should be understood by those skilled in the art that various modifications, combinations, sub-combinations and alterations may occur depending on design requirements and other factors insofar as they are within the scope of the appended claims or the equivalents thereof.

What is claimed is:

1. A fluorescent tube driving method for driving a fluorescent tube on the basis of an alternating current driving signal generated by an inverter circuit that uses a direct current power supply produced by directly rectifying the voltage of a commercial power supply as an input, the fluorescent tube driving method comprising the steps of:
detecting an input voltage supplied to the inverter circuit by using voltage detection means;
detecting an output current of the inverter circuit that drives the fluorescent tube on the basis of the alternating current driving signal by using electric current detection means; and
controlling, by using a controller, an alternating current driving signal generated by the inverter circuit on the basis of the output current of the inverter circuit, the output current being detected by the electric current detection means, and an input voltage supplied to the inverter circuit, the input voltage being detected by the voltage detection means, and suppressing a variation in the output current detected by the electric current detection means.

2. The fluorescent tube driving method according to claim 1, wherein the step in which the controller controls the alternating current driving signal generated by the inverter circuit on the basis of the output current and the input voltage and suppresses a variation in the output current detected by the electric current detection means comprises the steps of:
when the electric current detection means detects a variation in the output current of the inverter circuit, controlling, by using the controller, the alternating current driving signal generated by the inverter circuit in response to a variation in the output current and suppressing a variation in the output current detected by the electric current detection means; and
when the voltage detection means detects a variation in the input voltage supplied to the inverter circuit, correcting, by using the controller, the control of the alternating current driving signal generated by the inverter circuit, the control being performed in response to a variation in the output current.

3. The fluorescent tube driving method according to claim 1, wherein the voltage detection means detects an input voltage supplied to the inverter circuit on the basis of detection winding wire output induced in a detection winding wire of an inverter transformer provided in the inverter circuit, the detection winding wire output being induced in response to the input voltage.

4. The fluorescent tube driving method according to claim 1, further comprising the steps of detecting, by using the voltage detection means detects, an input voltage supplied to the inverter circuit on the basis of a divided voltage that is output in response to an input voltage supplied to the inverter circuit, the divided voltage being output by a voltage-dividing circuit provided on the output side of the direct current power supply produced by directly rectifying the voltage of the commercial power supply.

5. The fluorescent tube driving method according to claim 1, wherein the step in which the voltage detection means detects an input voltage supplied to the inverter circuit as a secondary winding wire output voltage induced in the secondary winding wire of the inverter transformer provided in the inverter circuit, and the controller controls the alternating current driving signal generated by the inverter circuit in response to the output current and the input voltage and suppresses a variation in the output current detected by the electric current detection means comprises the steps of:
when the electric current detection means detects a variation in the output current of the inverter circuit, controlling, by using the controller, an alternating current driving signal generated by the inverter circuit in response to the variation in the output current and suppressing a variation in the output current detected by the electric current detection means; and
correcting the control of the alternating current driving signal generated by the inverter circuit, the control being performed by the controller in response to the variation in the output current, on the basis of a phase difference between the secondary winding wire output voltage induced in the secondary winding wire of the inverter transformer, which is detected by the voltage detection means, and the output current of the inverter circuit, which is detected by the electric current detection means.

6. An inverter circuit for driving a fluorescent tube on the basis of an alternating current driving signal that is generated in such a manner that a direct current power supply produced by directly rectifying a commercial power supply is used as an input, the inverter circuit comprising:
a conversion circuit configured to generate the alternating current driving signal on the basis of the direct current power supply;
voltage detection means configured to detect an input voltage supplied to the conversion circuit;
electric current detection means configured to detect the output current of the conversion circuit for driving the fluorescent tube on the basis of the alternating current driving signal; and
a controller configured to control the alternating current driving signal generated by the conversion circuit on the basis of the output current of the conversion circuit, which is detected by the electric current detection means, and the input voltage supplied to the conversion circuit, which is detected by the voltage detection means, and suppresses a variation in the output current detected by the electric current detection means.

7. The inverter circuit according to claim 6, wherein, when the electric current detection means detects a variation in the output current of the conversion circuit, the controller controls the alternating current driving signal generated by the conversion circuit in response to a variation in the output current, suppresses the variation in the output current detected by the electric current detection means, and
when the voltage detection means detects the variation in the input voltage supplied to the conversion circuit, the controller corrects the control of the alternating current driving signal in response to the variation in the output current of the conversion circuit on the basis of the variation in the input voltage.

8. The inverter circuit according to claim 6, wherein the voltage detection means detects the input voltage supplied to the conversion circuit on the basis of detection winding wire output induced in the detection winding wire of the inverter transformer provided in the conversion circuit, the detection winding wire output being induced in response to the input voltage.

9. The inverter circuit claim 6, wherein the voltage detection means detects the input voltage supplied to the conversion circuit on the basis of the divided voltage that is output by a voltage-dividing circuit provided in the output of the direct current power supply produced by directly rectifying the commercial power supply in response to the input voltage supplied to the conversion circuit.

10. The inverter circuit claim 6, wherein the voltage detection means detects the input voltage supplied to the conversion circuit as a secondary winding wire output voltage induced in the secondary winding wire of the inverter transformer provided in the conversion circuit, and
when the electric current detection means detects a variation in the output current of the conversion circuit, the controller controls an alternating current driving signal generated by the conversion circuit in response to the variation in the output current and suppresses the variation in the output current detected by the electric current detection means, and corrects the control of the alternating current driving signal generated by the conversion circuit in response to the variation in the output current on the basis of a phase difference between the secondary winding wire output voltage induced in the secondary winding wire of the inverter transformer, which is detected by the voltage detection means, and the output current of the conversion circuit, which is detected by the electric current detection means.

11. A display apparatus comprising:
a liquid-crystal panel configured to display an image; and
a backlight apparatus configured to illuminate the liquid-crystal panel,
wherein the backlight apparatus includes
a fluorescent tube; and
an inverter circuit, and
wherein the inverter circuit includes
a conversion circuit configured to generate an alternating current driving signal for driving the fluorescent tube on the basis of a direct current power supply produced by directly rectifying a commercial power supply;
voltage detection means configured to detect an input voltage supplied to the conversion circuit; and
electric current detection means configured to detect the output current of the conversion circuit for driving the fluorescent tube on the basis of the alternating current driving signal; and
a controller configured to control the alternating current driving signal generated by the conversion circuit on the basis of the output current of the conversion circuit, the output current being detected by the electric current detection means, and the input voltage supplied to the conversion circuit, the input voltage being detected by the voltage detection means, and configured to suppress a variation in the output current detected by the electric current detection means.

12. A backlight apparatus for illuminating a liquid-crystal panel for displaying an image, the backlight apparatus comprising:
a fluorescent tube; and
an inverter circuit,
wherein the inverter circuit includes
a conversion circuit configured to generate an alternating current driving signal for driving the fluorescent tube on the basis of a direct current power supply produced by directly rectifying a commercial power supply;
voltage detection means configured to detect an input voltage supplied to the conversion circuit; and
electric current detection means configured to detect the output current of the conversion circuit for driving the fluorescent tube on the basis of the alternating current driving signal; and
a controller configured to control the alternating current driving signal generated by the conversion circuit on the basis of the output current of the conversion circuit, the output current being detected by the electric current detection means, and the input voltage supplied to the conversion circuit, the input voltage being detected by the voltage detection means, and configured to suppress a variation in the output current detected by the electric current detection means.

13. An inverter circuit for driving a fluorescent tube on the basis of an alternating current driving signal that is generated in such a manner that a direct current power supply produced by directly rectifying a commercial power supply is used as an input, the inverter circuit comprising:
a conversion circuit configured to generate the alternating current driving signal on the basis of the direct current power supply;
a voltage detector configured to detect an input voltage supplied to the conversion circuit;
an electric current detector configured to detect the output current of the conversion circuit for driving the fluorescent tube on the basis of an alternating current driving signal; and
a controller configured to control an alternating current driving signal generated by the conversion circuit on the basis of the output current of the conversion circuit, which is detected by the electric current detector, and the input voltage supplied to the conversion circuit, which is detected by the voltage detector, and suppresses a variation in the output current detected by the electric current detector.

14. A display apparatus comprising:
a liquid-crystal panel configured to display an image; and
a backlight apparatus configured to illuminate the liquid-crystal panel,
wherein the backlight apparatus includes
a fluorescent tube; and
an inverter circuit, and
wherein the inverter circuit includes
a conversion circuit configured to generate an alternating current driving signal for driving the fluorescent tube on the basis of a direct current power supply produced by directly rectifying a commercial power supply;
a voltage detector configured to detect an input voltage supplied to the conversion circuit; and
an electric current detector configured to detect the output current of the conversion circuit for driving the fluorescent tube on the basis of the alternating current driving signal; and
a controller configured to control the alternating current driving signal generated by the conversion circuit on the basis of the output current of the conversion circuit, the output current being detected by the electric current detector, and the input voltage supplied to the conversion circuit, the input voltage being detected by the voltage detector, and configured to suppress a variation in the output current detected by the electric current detector.

15. A backlight apparatus for illuminating a liquid-crystal panel for displaying an image, the backlight apparatus comprising:
a fluorescent tube; and
an inverter circuit,
wherein the inverter circuit includes
a conversion circuit configured to generate an alternating current driving signal for driving the fluorescent tube on the basis of a direct current power supply produced by directly rectifying a commercial power supply;
a voltage detector configured to detect an input voltage supplied to the conversion circuit; and
an electric current detector configured to detect the output current of the conversion circuit for driving the fluorescent tube on the basis of the alternating current driving signal; and
a controller configured to control the alternating current driving signal generated by the conversion circuit on the basis of the output current of the conversion circuit, the output current being detected by the electric current detector, and the input voltage supplied to the conversion circuit, the input voltage being detected by the voltage detector, and configured to suppress a variation in the output current detected by the electric current detector.
